(19) United States
(12) Patent Application Publication
(10) Pub. No.: US 2025/0235823 A1
(43) Pub. Date: Jul. 24, 2025

(54) DIESEL EXHAUST FLUID WITH INORGANIC ADDITIVE

(71) Applicant: JSIP, LLC, Conshohocken, PA (US)

(72) Inventor: Ronald D. Kurp, Shamong, NJ (US)

(21) Appl. No.: 18/421,428

(22) Filed: Jan. 24, 2024

(51) Int. Cl. B01D 53/94

(52) U.S. Cl. CPC B01D 53/9418; B01D 2257/404; B01D 2258/012; B01D 2259/124; B01D 2259/4566

(57) ABSTRACT

A diesel exhaust fluid (DEF) for reducing nitrogen oxides in diesel exhaust streams while also reducing the deposition of urea and/or urea decomposition compounds in diesel exhaust systems of engines that use DEF and require selective catalytic reduction. The DEF has about 15 wt. % to about 40 wt % process purified urea; substantially purified water; and a compound additive that stabilizes the DEF product, generates water in the diesel exhaust streams at temperatures greater than 100° C., interferes with competing reactions that would otherwise prevent decomposition of urea or produce undesired decomposition deposit compounds including biuret, cyanuric acid, ammelide, ammeline, and melamine, or both generates water and interferes with the competing reactions at lower temperatures. The compound additive is an inorganic such as boric acid. Also disclosed are a related method of using the DEF in a diesel exhaust system and a system including the DEF as one component.

### TECHNICAL FIELD

The present disclosure relates generally to formulations of diesel exhaust fluid (DEF) and, more particularly, to compositions, systems, and methods that reduce the accumulation of urea and/or urea decomposition compounds in diesel exhaust systems of engines that use DEF and require selective catalytic reduction.

### BACKGROUND OF THE DISCLOSURE

Diesel engines are a preferred mechanism to produce torque for use in a wide range of applications including transportation, off-road agricultural and mining equipment, and the large-scale production of on-site electrical power. Their virtually unmatched power-to-mass ratios and the relative safety of their fuel make diesel engines almost the only choice for use in specific applications such as long-haul trucks, trains, tractors, earth movers, combines, surface mining equipment, non-electric locomotives, high capacity emergency power generators, and the like.

Diesel engines operate at high internal temperatures. One consequence of their high operating temperatures is that at least some of the nitrogen present in the engine at the moment of combustion may combine with oxygen to form nitrogen oxides (NOₓ) including species such as NO and NO₂. Another consequence of the high operating temperatures is that diesel exhaust at or near the point of exit from the engine and into the exhaust pipe is very hot.

A compound such as NOₓ is problematic because it readily combines with volatile organic compounds in the atmosphere to form smog. NOₓ is regarded as a pollutant and virtually every industrialized nation regulates the levels of NOₓ that can be legally discharged into the atmosphere. The exhaust emissions regulations governing NOₓ are expected to become even more strict. Fortunately, engine and equipment manufacturers have developed methods, systems, and compositions for reducing the levels of NOₓ produced by the combustion of diesel fuel and released into the environment.

The favored method to reduce nitrogen oxides, protecting the environment and keeping the air quality as clean as possible, is selective catalytic reduction (SCR) using ammonia as a reducing agent. Although ammonia itself could be used in SCR as the reductant, ammonia is a volatile, corrosive, and poisonous substance. Given the related safety issues, automotive vehicles such as passenger cars cannot be equipped with an ammonia tank. It might also be possible to use ammonia in combination with urea as the reducing agent. That possibility is impractical, however, because the combination creates competing reactions that hamper NOₓ reduction and reduce SCR performance. Therefore, in general, a urea water solution (UWS) is widely used as the reducing agent in SCR and, more specifically, as an after-treatment for diesel engines. (The relatively high freezing point of urea in water solutions is problematic and has prompted consideration of nitrogen-based reductants which have lower freezing points than UWS; although such reductants can function, they offer inferior performance.) Urea is broken down (i.e., decomposes) through thermolysis and hydrolysis to ammonia and carbon dioxide when dosed by dispersion into the hot exhaust pipe. The ammonia produced can then act as the reductant.

The UWS is also known by the names AdBlue or diesel exhaust fluid (DEF). UWS formulations typically include about 32.5 wt. % urea and pure water. The quality of the UWS used as a NOₓ reducing agent in SCR converter systems must be specified to ensure reliable and stable operation of the SCR converter systems. Enter the International Organization for Standardization (ISO), a worldwide federation of national standards bodies. The ISO 22241 series provides the specifications for quality characteristics; for handling, transportation, and storage; and for the refilling interface as well as the test methods needed by the manufacturers of motor vehicles and their engines, by converter manufacturers, by producers and distributors of the UWS, and by fleet operators. More specifically, DEF, Diesel Exhaust Fluid: ISO-22241-1 (published February 2019 and available at www.iso.org) specifies the quality characteristics of the NOₓ reducing agent AUS 32 (aqueous urea solution) which is needed to operate SCR converter systems in motor vehicles with diesel engines.

During the desired decomposition of urea at temperatures above 130° C., undesired intermediates and by-products in liquid and solid form are produced and can stick to the wall of the exhaust pipe due to the inevitable interaction between the spray and the pipe wall. The urea deposits tend to form in the exhaust system especially between the DEF dosing inlet and upstream of the SCR catalyst. These deposits are mainly made up of cyanuric acid after the incomplete decomposition of urea (i.e., insufficient conversion to ammonia). The condensed urea deposits in the exhaust pipe can plug the pipe and create the risk of increased pressure drop.

Attempts have been made to reduce urea deposits in exhaust systems of engines that use DEF requiring SCR catalysts by modifying the DEF formulation. See, for example, U.S. Pat. Nos. 8,999,277 and 8,961,818 issued to Deere & Company of Illinois based on prior Patent Application Publication No. US 2014/0369910. Described are formulations of DEF that include low levels of formaldehyde, or other aldehydes including but not limited to acetaldehyde, propionaldehyde, or butyraldehyde.

Another modification of the DEF formulation that attempts to reduce urea deposits focused on minimizing the diameter of urea droplets. See U.S. Pat. No. 9,050,560 issued to Yara International ASA, a Norwegian chemical company, in 2015 based on prior Patent Application Publication No. US 2011/0233461. An even distribution of urea droplets with extraordinarily small diameters is achieved by influencing the spraying conditions by supplying an additive to the urea solution. Disclosed is a mixture of surfactants from alkylene oxide adducts with different degrees of alkoxylation. The mixture is used in a urea solution to be added to an exhaust stream for reduction of nitrous gases.

Old World Industries, LLC of Northbrook, Illinois offers a DEF product under the trademark “Blue DEF PLATINUM.” The product is a mixture of high purity synthetic urea, deionized water, and a proprietary additive. Product advertising touts use of the product to reduce the formation of deposits that build up in diesel exhaust systems. It was reported that “lower” running temperatures of diesel engines experience this issue more frequently. Examples of such engines might include trash trucks, electrical generators, and other engines that often experience long periods of idling.

Given the problem of deposits in the exhaust pipe, the decomposition kinetics of urea and its by-products have been extensively studied by many authors. See, e.g., S. Tischer et al., “Thermodynamics and reaction mechanism of urea decomposition,” Phys. Chem. Chem. Phys., vol. 21, pages 16, 785-97 (2019) (focuses on a reaction scheme for the formation and decomposition of undesired by-products deposited in the exhaust pipe that emphasizes the role of thermodynamic equilibrium of the reactants in liquid and solid phases); J. Mutyal et al., “Analysis of the injection of urea-water-solution for automotive SCR systems: spray/exhaust-gas-interaction,” ILASS-Europe 2014, 26th Annual Conference on Liquid Atomization and Spray Systems (Bremen, Germany Sep. 8-10, 2014) (focuses on evaporation and mixing modeling of the UWS); and F. Birkhold et al., “Modeling and simulation of the injection of urea-water-solution for automotive SCR DeNOₓ-systems,” Applied Catalysis B: Environmental, vol. 70, pages 119-27 (2007) (investigates theoretically the evaporation of water from a single droplet of UWS).

Despite these studies and the many attempts made to reduce urea deposits in exhaust systems of engines that use DEF requiring SCR catalysts, much work remains to be done. An outline of that work is provided by the Southwest Research Institute (SwRI) in its Proposal No. 03-83490 titled “A Proposal for AC²AT-II/Advanced Combustion Catalyst And Aftertreatment Technologies” (April 2018). The applicant's own International Patent Application No. PCT/US2021/062028, filed on Dec. 6, 2021, and titled “Diesel Exhaust Fluid with Additive,” is part of that work. The present document seeks to further the work.

With ever tighter limits on the amount of nitrogen oxide compounds that can be released into the atmosphere, there remains a need for improved methods, systems, and compositions for reducing the levels of NOₓ. Therefore, an object of this disclosure is, and it would be a great advantage, to provide a UWS that better reduces the amount of nitrogen oxides in exhaust gases by SCR. Related objects are to facilitate urea decomposition, avoid deposition of urea and its decomposition by-products on exhaust pipe walls, and increase the efficiency of NOₓ reduction by SCR.

### SUMMARY OF THE DISCLOSURE

In view of these and other objects, to meet these and other needs, and in view of its purposes, the present disclosure provides a diesel exhaust fluid (DEF) for reducing nitrogen oxides in diesel exhaust streams while also significantly reducing the deposition of urea and/or urea decomposition compounds in diesel exhaust systems of engines that both (i) use DEF even at lower operating temperatures and (ii) require selective catalytic reduction. The DEF has about 15 wt. % to about 40 wt % urea; substantially purified water; and an inorganic compound additive that generates water in the diesel exhaust streams at temperatures greater than 100° C. (or 140° C., or 180° C., or 530° C.), interferes with competing reactions that would otherwise prevent decomposition of urea or produce undesired decomposition deposit compounds including biuret, cyanuric acid, ammelide, ammeline, and melamine, or both generates water and interferes with the competing reactions. The compound additive is preferably ultra-high purity boric acid (CAS 10043-35-3). Also disclosed are a related method of using the DEF in a diesel exhaust system and a system including the DEF as one component.

It is to be understood that both the foregoing general description and the following detailed description are exemplary, but are not restrictive, of the disclosure.

### BRIEF DESCRIPTION OF THE DRAWING

The disclosure is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a schematic diagram of a typical heavy-duty diesel exhaust SCR treatment system;

FIG. 2 is a schematic diagram showing mixture preparation and the catalytic reduction process in the SCR system;

FIG. 3 is a graph showing the results of testing done to evaluate the stability of DEF having an inorganic compound additive (namely, boric acid); and

FIG. 4 is a schematic illustration of the test system used to evaluate the effectiveness of the DEF having boric acid on reducing deposits of urea residue that tend to form in the exhaust system.

### DETAILED DESCRIPTION OF THE DISCLOSURE

In this specification and in the claims that follow, reference will be made to a number of terms which shall be defined to have the following meanings ascribed to them.

“Include,” “includes,” “including,” “have,” “has,” “having,” comprise,” “comprises,” “comprising,” or like terms mean encompassing but not limited to, that is, inclusive and not exclusive. The indefinite article “a” or “an” and its corresponding definite article “the” as used in this disclosure means at least one, or one or more, unless specified otherwise.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is described to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point. Whether or not a numerical value or end-point of a range in the specification recites “about,” the numerical value or end-point of a range is intended to include two embodiments: one modified by “about” and one not modified by “about.” It will be further understood that the end-points of each of the ranges are significant both in relation to the other end-point and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described.

Diesel Exhaust Fluid (DEF) is a non-toxic, high purity chemical solution comprised of 32.5% urea and 67.5% de-ionized water for specific use in selective catalytic reduction (SCR) systems. SCR is an exhaust after treatment system that injects a small amount of DEF into the exhaust. DEF is mixed with exhaust in the presence of a catalyst turning NOₓ (oxides of nitrogen which constitute a harmful pollutant that contributes to smog and acid rain) into harmless nitrogen and water molecules. Nitrogen makes up about 78% of the air we breathe. Using DEF in diesel-powered vehicles, such as trucks, buses, and tractors, helps to reduce the amount of NOₓ emitted into the air by at least 90%, and in some cases to near zero levels, while providing a 3-5% savings on diesel fuel usage. DEF is not a fuel additive and must be filled into the dedicated DEF tank on a diesel vehicle. Without DEF, diesel vehicles will not function.

Also known as carbamide or carbonyl diamide, urea is the active ingredient in DEF. Urea has the chemical formula CO(NH₂)₂, is created from synthetic ammonia and carbon dioxide, and is commercially available in both solution and solid forms. Producers of synthetic urea supply two grades of urea: automotive grade and agricultural grade. Producers of agricultural grade urea typically inject formaldehyde additives into the liquid or molten urea, in concentrations of 0.5% or less, because formaldehyde reacts with urea to from methylenediurea, which is a conditioning agent able to reduce urea dust emissions and to prevent solid urea product from caking during storage. Formaldehyde is an organic compound with the formula CH₂O and is the simplest of the aldehydes (R—CHO). Unlike urea used in agricultural applications such as fertilizers, automotive grade urea does not contain formaldehyde and typically must be used in the production of DEF (as opposed to agricultural grade urea). Formaldehyde and other impurities in the urea can cause damage to the catalyst in an SCR system. It would be desirable to provide a DEF, however, that can incorporate both grades of urea (even the agricultural grade including formaldehyde) without adverse effects.

Currently available technology used to reduce the amount of nitrogen oxide (NOₓ) emissions that are emitted in diesel exhaust streams includes selective catalytic reduction (SCR). This technology is widely used to reduce NOₓ emissions from heavy duty diesel engines and takes advantage of the high temperatures found in diesel exhaust streams. In a typical SCR-based exhaust treatment system, a SCR catalyst is positioned in the exhaust stream of a diesel engine. The catalyst is positioned such that the temperature of the exhaust stream contacting the surface of the catalyst is high enough to sustain the reaction of the NOₓ in the exhaust stream with the reductant but not so high that the heat produced by the engine and the chemical reactions that take place in the exhaust stream damages the catalyst.

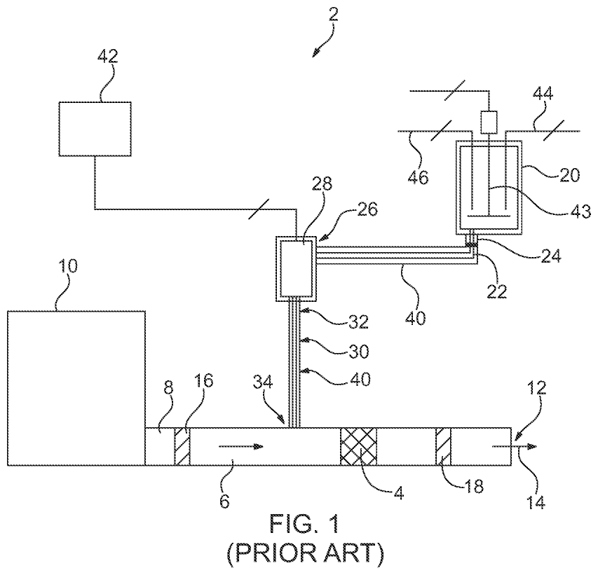

Referring now to the drawing, FIG. 1 is a schematic diagram of a typical heavy-duty diesel exhaust treatment SCR system 2. A SCR catalyst 4 is positioned within an exhaust pipe 6. The exhaust pipe 6 has two ends. One end 8 is connected to a source 10 of NOₓ and the other end 12 is vented to the atmosphere in the direction of an arrow 14. A typical system 2 may also include, optionally, an additional pair of oxidation catalysts 16 and 18 that are positioned before (catalyst 16) and after (catalyst 18) the SCR catalyst 4. The oxidation catalysts function to catalyze the oxidation of various compounds in the exhaust stream including organic molecules and un-reacted ammonia.

Because the SCR system 2 requires a reductant such as ammonia or urea, the SCR system 2 includes a mechanism for storing and delivering the reductant to the catalyst. Still referring to FIG. 1, a reductant storage vessel 20 is connected to a first delivery tube 22. The first delivery tube 22 has an inlet 24 connected to the storage vessel 20 and an outlet 26 connected to a reductant delivery valve 28 that regulates the flow of the reductant from the first delivery tube 22 to a second delivery tube 30. The second delivery tube 30 also has an inlet 32 connected to the outlet of the valve 28 and an outlet 34 connected to the exhaust pipe 6. The outlet 34 of the second delivery tube 30 is connected to the exhaust pipe 6 such that the reductant in the second delivery tube 30 is delivered onto or near the surface of the SCR catalyst 4 by the outlet 34.

In some embodiments, the SCR system 2 may include a device for maintaining the temperature of the reductant in the storage vessel 20. In some configurations, the first reductant delivery tube 22, the reductant delivery valve 28, and/or the second reductant delivery tube 30 may include a device 40 to help regulate the temperature of the reductant in the system 2. In some embodiments, the device 40 is selected from the group consisting of insulation, a heating coil or sock, a cooling or warming jacket, or some combination of them.

In some embodiments, the SCR system 2 further includes an optional mixer 43 supplied to either periodically or continuously agitate the contents of the reductant storage vessel 20. The vessel 20 may also be equipped with a temperature sensor 44 to measure the temperature of the contents of the vessel 20. The vessel 20 may also have a probe 46 for measuring the nitrogen content of the material stored in the vessel 20. In some embodiments, the SCR system 2 may have a controller 42 which may include inputs from sensors connected to the exhaust and/or the SCR system 2.

The controller 42 has a central processing unit (CPU) or dedicated logic circuits that regulate the dispersion of reductant to the system 2 as necessary to maintain the release of NOₓ within acceptable limits. The controller 42 can monitor the temperature of the reductant delivery system and perhaps control portions of the system 2 dedicated to maintaining the reductant within an acceptable temperature range. In some embodiments, the same controller 42 is used to regulate the rate, frequency, or both of the mixer 43 associated with the reductant storage vessel 20. In some embodiments, the controller 42 monitors the level of reductant, the composition of the reductant, or both the level and the composition of the reductant in the reductant storage vessel 20.

The problem of urea deposition in the SCR system 2 can cause reduced fuel efficiency, particulate filter failure, damage to the SCR catalyst bed, and even engine failure as a significant build-up of urea in the exhaust system can cause excessive back pressure. The SCR system 2 is equipped optionally with pressure sensors, in part to detect the effects of urea deposition. These sensors are part of a monitoring unit that enables the diesel operator to detect problematic urea buildup and to take appropriate action such as shutting down the SCR system 2 until the deposits can be physically removed from the SCR system 2. Still other systematic approaches to addressing the problem of urea build-up are to alter the position of the DEF feed tube and to time the release of DEF into a portion of the SCR system 2 immediately up-stream of the SCR catalytic bed in order to minimize the time that urea-rich DEF is in contact with the DEF feed system and pre-SCR section of the SCR system 2.

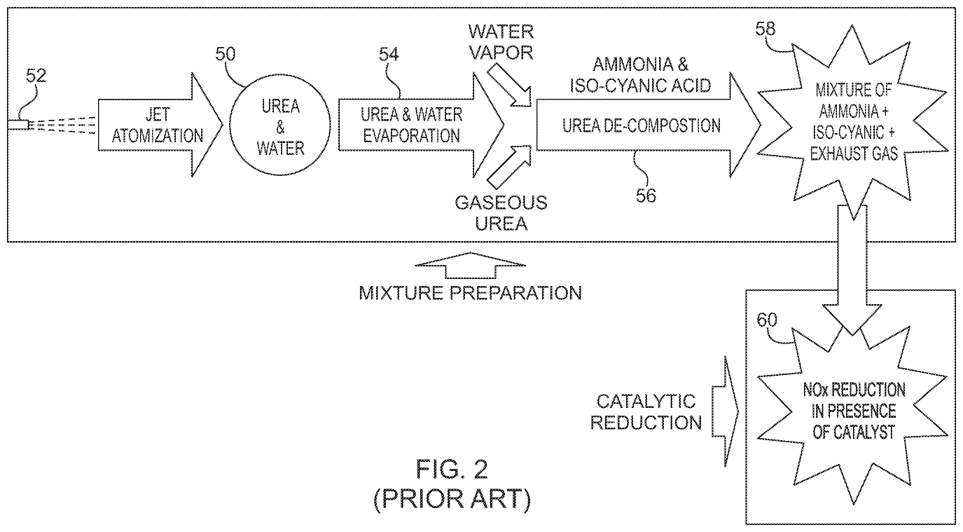

FIG. 2 is a schematic diagram showing mixture preparation and the catalytic reduction process in the SCR system 2. The UWS 50 (typically a 32.5% wt. solution of urea in water) is injected (i.e., sprayed) as the reductant into the hot exhaust gas stream and undergoes atomization. The UWS is atomized with the help of a narrow nozzle 52. The diameter of the droplets should be very small to achieve a high temperature in a short time in the exhaust gas stream, thus leading to a thorough hydrolysis of the urea. Bigger droplets may stick to the wall of the exhaust pipe or material of the catalyst if the droplets are not evenly distributed. In this case the water evaporates quickly in the hot exhaust stream and other reactions will take place.

When UWS is atomized into the hot exhaust gas stream, the droplets are heated and, due to the low vapor pressure of urea compared to the vapor pressure of water, water evaporates first from the droplets. The subsequent generation of ammonia (NH₃) in the hot exhaust gas proceeds in three steps, as follows.

(1) The water component is first released from the liquid UWS by vaporization. Vaporization or evaporation (Step 54) of water from a fine spray of UWS droplets proceeds according to the equation: (NH₂)₂CO(aqueous)→(NH₂)₂CO(solid or liquid)+6.9H₂O(gas).

(2) After water vaporization, the remaining urea starts to decompose (Step 56) at higher temperature. Urea starts melting at 133° C. (or 406 K because the conversion of Kelvin to Celsius is K=° C.+273) and the thermal decomposition of urea into ammonia and isocyanic acid starts. Vigorous decomposition starts at approximately 140° C. (413 K). Thermolysis becomes fully evident above 152° C. (425 K). Urea thermolysis and formation of ammonia and isocyanic acid (Step 58) proceed according to the equation: (NH₂)₂CO(solid or liquid)→(HN₃)(gas)+HNCO(gas). Although this equation is a single-step and rather simplistic description of the decomposition of urea, formation of polymeric compounds including biuret, cyanuric acid, ammelide, ammeline, and melamine is observed during the urea decomposition reaction.

(3) Finally, the hydrolysis of isocyanic acid proceeds at higher temperature to generate ammonia according to the equation: HNCO(gas)+H₂O(gas)→(NH₃)(gas)+CO₂(gas).

The ammonia that is generated in the hot exhaust gas reacts with NOₓ in the presence of a catalyst 60 to produce nitrogen and water. Some of the reactions that occur on the surface of the SCR catalyst in SCR-based exhaust treatment systems include the following:

4NH₃+4NO+O₂→4N₂+6H₂O;

2NH₃+NO+NO₂→2N₂+3H₂O; and

8NH₃+6NO₂→7N₂+12H₂O.

Thus, typical chemical reactions facilitated by SCR catalysts are the reduction of NOₓ (such as NO₂ or NO) to N₂ and H₂O.

As stated above, one significant limitation of SCR systems is deposit formation as a result of incomplete urea decomposition. When isocyanic acid (HNCO) undergoes reactions other than hydrolysis, deposit formation commences. Some of these reactions are illustrated as follows:

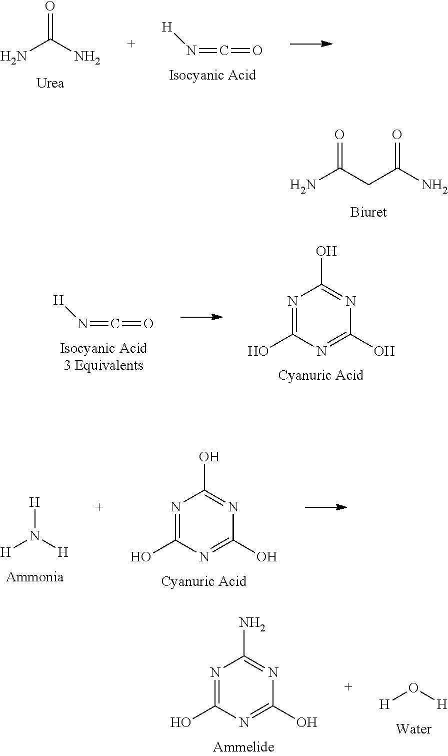

The urea-derived deposits consist of various molecular species such as biuret, cyanuric acid, ammeline, melamine, and ammelide—among others.

The present disclosure relates to a method, system, and composition for reducing the deposition of urea and related by-products in the exhaust systems of engines that use DEF and require SCR. A basis for the disclosure is the recognition that, after completion of the three steps listed above by which ammonia is generated in the hot exhaust gas, insufficient water may be present at the urea decomposition temperatures to facilitate the reactions necessary to complete urea decomposition. For example, biuret can be hydrolyzed to NH₃ and CO₂. That hydrolysis reaction will not take place in practice, however, given the lack of water in the dried UWS droplets. Instead, a detrimental melamine deposit is formed in an alternative reaction. This recognition is supported in the published research, outlined above, that reviews the thermodynamics and reaction mechanisms of urea decomposition and urea DeNOₓ.

Having recognized the problem, the present disclosure provides a method, system, and composition that generate water in the DEF environment in which the relevant chemical reactions occur (e.g., at temperatures greater than 100° C. (373 K) or 125° C. (398 K) or 150° C. (423 K)); interfere with the competing reactions that would otherwise produce undesired deposit compounds such as melamine; or both. Contemplated is the addition of a compound (i.e., an additive) to the DEF. Any compound addition to DEF must be non-hazardous during production, transport, and storage; while in the solution; and after being oxidized in an exhaust system.

The DEF according to the present disclosure begins with urea of nearly any quality. Technically pure urea is an industrially produced grade of urea (CAS Number 57-13-6) with only traces of biuret, ammonia, and water, free of aldehydes or other substances such as anticaking agent, and free of contaminants such as sulfur and its compounds, chloride, nitrate, or other compounds. A CAS Number is a numerical designation for chemicals that is maintained by the Chemical Abstracts Service (CAS) of the American Chemical Society. Each number assigned by the CAS is unique to one chemical substance. CAS numbers are utilized in a range of databases to make it faster to retrieve the pertinent information about that particular chemical. The physical properties of urea include a density of 1,280 kg/m³; a specific heat of 2,375 j/kg-k; a vaporization temperature of 147° C. (420 K); and a boiling temperature of 210° C. (483 K). Urea of lesser quality may contain contaminants such as dissolved elements, aldehyde-generating compounds, and others that would normally disqualify the urea as “DEF quality,” but can be treated by this process and additive to meet the ISO-22241 specifications.

Water is added to the urea to create a UWS. Typically, the UWS includes on the order of about 15 wt. % to about 40 wt % (preferably about 32.5 wt. %) urea and substantially purified (e.g., demineralized or deionized) water. The compound addition is included in the UWS to create the final DEF composition ready for use in the intended application. The final DEF composition can be tailored or predetermined to best reduce the deposition of urea and related by-products in the exhaust systems of specific engine applications. By “predetermined” is meant determined beforehand, so that the predetermined characteristic (composition) must be determined, i.e., chosen or at least known, in advance of some event (use in the exhaust system).

The DEF composition is optimized to prolong catalyst life and to include extremely low levels of impurities that can cause deposits or poison expensive SCR catalysts. U.S. Pat. No. 7,914,682 issued to Colonial Chemical Company of New Jersey and is incorporated into this document by reference in its entirety. As its title “Method for Removing Impurities from a Urea Solution” indicates, the '682 patent discloses a method of, and a system for, removing impurities from a urea solution. The method and system involve contacting the aqueous solution with an ion exchange resin and adsorbing the impurities from the urea solution. Optionally, the disclosed method and system can be applied to the DEF composition of the present disclosure. Accordingly, the DEF compositions disclosed in this document have virtually undetectable levels of sulfur, metals, noncombustible fillers, other inert contaminants, and compounds whose effects on SCR catalyst life are unknown.

Although application of the method and system disclosed in the '682 patent removes cations and anions that would typically disqualify a urea solution as DEF quality, the technology does not remove aldehyde-generating type compounds that may be present in the solution. The addition of an inorganic compound according to the present disclosure lowers the aldehyde results, however, to meet the specification of less than 5 ppm, as tested by the procedure Annex F, ISO-22241. The addition of the inorganic compound renders economically viable the processing of contaminated urea solutions to ISO-22241 quality and allows for a “recycling loop” of out-of-specification material. This advantage becomes more important as usage levels of DEF increase, the generation of contaminated urea solutions increases, and the sources of pure urea solutions that are commercially available become more limited.

The addition of the inorganic compound also forms a stabilizing/buffering-type DEF solution that has better storage stability. The DEF composition including the inorganic compound additive is spray injected into the gas stream of an application (e.g., automotive). The spray typically has a Sauter mean diameter of about 20-150 μm, an exit velocity of about 5-25 m/s, and an injection temperature of about 27-77° C. (300-350 K). The exhaust velocity is typically about 5-100 m/s at a temperature of about 127°-727 C (400-1,000 K). The temperature of the wall of the exhaust pipe is about 77-627° C. (350-900 K). The inorganic compound additive significantly reduces the accumulation of urea and/or urea decomposition compounds in diesel exhaust systems.

### EXAMPLES

The following examples are included to more clearly demonstrate the overall nature of the disclosure. These examples are exemplary, not restrictive, of the disclosure.

One suitable DEF inorganic compound additive is boric acid. Boric acid, more specifically orthoboric acid, is a compound of boron, oxygen, and hydrogen with the molecular formula B(OH)₃ or H₃BO₃ or BH₃O₃. It may also be called hydrogen orthoborate, trihydroxidoboron, or boracic acid. It is usually encountered as colorless crystals or a white powder, that dissolves in water, and occurs in nature as the mineral sassolite. It is a weak acid that yields various borate anions and salts, and can react with alcohols to form borate esters. Boric acid is identified by CAS Number 10043-35-3.

The use of boric acid in the petrochemical industry is not unknown. For example, Australia Patent Publication No. AU2013101665 (2014) discloses a fuel additive and a fuel incorporating the additive. The additive is based on aliphatic alcohols, carbamide (urea), and water, characterized by also containing boric acid. In one embodiment, the additive has the following ratio of components in mass %: aliphatic alcohols (C2-C4)=1-97.99%; carbamide (urea)=1-30%; boric acid=0.01-3%; and water=1-85%.

Boric acid is commercially available from the American Borate Company of Virginia Beach, Virginia, in standard (normal), low-sulfate, and ultra-low sulfate grades. The amount of sulfate or sulphate ion (SO₄) is about 300 ppm maximum in the normal sulfate grade; about 150 ppm maximum in the low sulfate grade; and about 12 ppm maximum in the ultra-low sulfate grade. The ultra-low sulfate grade boric acid actually obtained from the American Borate Company and used in testing (see below) had a sulfate amount of about 0.65 ppm. Preferably, the boric acid used as the inorganic additive is the ultra-low sulfate grade; the boric acid should be substantially pure with minimal (preferably no) sulfur content. Sulfur is poison to (i.e., it destroys) the catalyst in an SCR system.

The amount of boric acid used as the inorganic additive is preferably in the range of about 0.1 to 3% by weight; more preferably, about 0.1 to 2% by weight, and most preferably, about 0.1 to 1% by weight. Testing done to date (see below) indicates that about 1% of boric acid works well and may be optimum. Little benefit is expected for the DEF when more than about 3% of boric acid is added, and the addition of more boric acid increases the cost of the solution and risks adverse effects. When boric acid in an amount of 0.1 to 1% by weight is added to the DEF product containing formaldehyde, post resin treatment, the DEF will have less than 5 ppm of formaldehyde as tested by Annex F, ISO 22241.

Another suitable DEF inorganic compound additive is ammonium borate. The general chemical formula for ammonium borate is (NH₄)3(BO₃)₂. Ammonium borate is often synthesized through the reaction of boric acid with ammonium hydroxide (NH₄OH). This reaction results in the formation of the ammonium borate compound and water. It is important to conduct this reaction under controlled conditions to prevent the decomposition of the resultant product. Although ammonium borate may be a suitable inorganic additive, the focus of testing was on boric acid.

In one particular test, calculations were made using the equations of the three steps enumerated above in connection with FIG. 2. Molecular weights are listed in parenthesis (in units of g/mol); amounts are listed in brackets.
(1) (NH₂)₂CO(60.056)→(NH₂)₂CO(60.056)+6.9H₂O;
(2) (NH₂)₂CO(60.056)→(HN₃)(17.031)+HNCO(43.03) [ammonia=28.35%/isocyanic acid=71.65%]; and
(3) HNCO(43.03)+H₂O(18.01)→(NH₃)(17.03)+CO₂(44.01) [acid=70.5%/Water=29.5%][ammonia=27.9%/carbon dioxide=72.1%]
(4) The dehydration reaction of boric acid (which has a molecular weight of 61.84) produces boron oxide and water according to the equation:

2B(OH)₃ [symbol] B₂O₃+H₂O.

This dehydration reaction was run at three temperatures: 140° C., 180° C., or 530° C. This chemical reaction is reversible, meaning that the reactants form products that, in turn, react together to give the reactants back. Reversible reactions will reach an equilibrium point where the concentrations of the reactants and products will no longer change.

Urea-formaldehyde (UF), also known as urea-methanal, so named for its common synthesis pathway and overall structure, is produced from urea and formaldehyde. The UF used in testing (see below) had a formaldehyde amount of about 4,000 ppm. The addition of boric acid or ammonium borate provides the ability to process UF for DEF use and reduce residue at lower operating temperature in diesel exhaust systems. Thus, a broader source of urea for DEF applications is realized: automotive grade or “non-formaldehyde” urea is no longer required for the production of DEF. Contaminated product such as agricultural grade urea containing formaldehyde can be “recycled” to meet ISO specifications.

### A. Stability Testing (1,500 Hours)

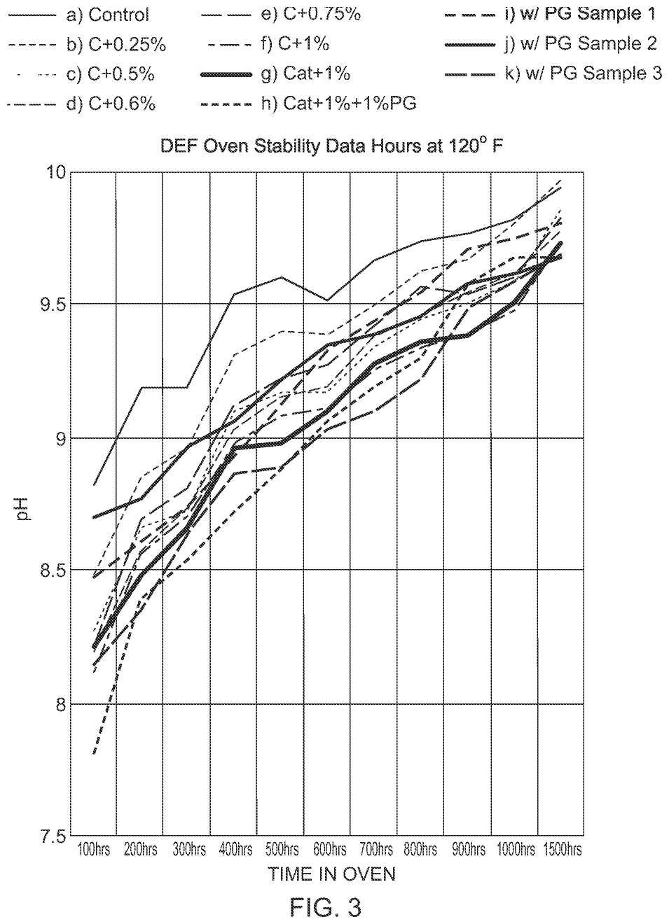

Testing was done to evaluate the stability of the DEF having boric acid. The three Tables below show the results of oven stability test data for eleven different samples at 120° F. from 100 to 1,500 hours. Two characteristics of the samples were tested: pH and odor. Table 1 identifies the samples; Table 2 provides the pH results (the initial pH of the control, Sample A, was 8.3); and Table 3 provides the odor results. FIG. 3 is a graph of the results shown in Table 2.

TABLE 1
(Sample Identification)

| Sample | |
|---|---|
| Letter | Sample Description |
| A | Control = 32.5% Urea + Formaldehyde (no boric acid or |
| | cationic resin) |
| B | Control + 0.25% boric acid |
| C | Control + 0.5% boric acid |
| D | Control + 0.6% boric acid |
| E | Control + 0.75% boric acid |
| F | Control + 1.0% boric acid |
| G | Control through cationic resin + 1.0% boric acid |
| H | Control through cationic resin + 1.0% boric acid + 1% |
| | propylene glycol |
| I | Control + 0.85% boric acid + 0.5% propylene glycol |
| J | Control + 0.6% boric acid + 0.5% propylene glycol |
| K | Control + 0.75% boric acid + 0.5% propylene glycol |

TABLE 2
(pH)

| SAMPLE | 100 hrs | 200 hrs. | 300 hrs | 400 hrs | 500 hrs | 600 hrs | 700 hrs | 800 hrs | 900 hrs | 1000 hrs | 1500 hrs |
|---|---|---|---|---|---|---|---|---|---|---|---|
| A | 8.82 | 9.19 | 9.19 | 9.54 | 9.60 | 9.52 | 9.67 | 9.74 | 9.77 | 9.82 | 9.95 |
| B | 8.49 | 8.85 | 8.96 | 9.31 | 9.40 | 9.39 | 9.5 | 9.63 | 9.67 | 9.81 | 9.97 |
| C | 8.28 | 8.66 | 8.72 | 9.1 | 9.17 | 9.17 | 9.34 | 9.45 | 9.51 | 9.59 | 9.86 |
| D | 8.2 | 8.57 | 8.74 | 9.03 | 9.15 | 9.19 | 9.38 | 9.46 | 9.55 | 9.62 | 9.78 |
| E | 8.22 | 8.69 | 8.81 | 9.12 | 9.22 | 9.27 | 9.42 | 9.57 | 9.54 | 9.60 | 9.83 |
| F | 8.12 | 8.56 | 8.7 | 8.98 | 9.08 | 9.11 | 9.25 | 9.34 | 9.39 | 9.48 | 9.74 |
| G | 8.22 | 8.48 | 8.66 | 8.96 | 8.98 | 9.1 | 9.28 | 9.36 | 9.39 | 9.51 | 9.74 |
| H | 7.81 | 8.39 | 8.54 | 8.72 | 8.88 | 9.06 | 9.19 | 9.3 | 9.58 | 9.68 | 9.68 |
| I | 8.48 | 8.61 | 8.74 | 8.93 | 9.12 | 9.33 | 9.44 | 9.55 | 9.71 | 9.75 | 9.81 |
| J | 8.7 | 8.77 | 8.97 | 9.06 | 9.22 | 9.35 | 9.39 | 9.46 | 9.58 | 9.62 | 9.68 |
| K | 8.15 | 8.35 | 8.64 | 8.56 | 8.89 | 9.03 | 9.1 | 9.22 | 9.49 | 9.59 | 9.69 |

TABLE 3
(Ammonia Odor)

| SAMPLE | 100 hrs | 200 hrs | 300 hrs | 400 hrs | 500 hrs | 600 hrs | 700 hrs | 800 hrs | 900 hrs | 1000 hrs | 1500 hrs |
|---|---|---|---|---|---|---|---|---|---|---|---|
| A | WA | WA | A | A | SA | SA | SA | SA | SA | SA | SA |
| B | None | None | None | WA | A | A | A | A | A | A | A |
| C | None | None | None | VWA | VWA | WA | WA | WA | WA | WA | WA |
| D | None | None | None | VWA | VWA | WA | WA | WA | WA | WA | WA |
| E | None | None | None | VWA | VWA | WA | WA | WA | WA | WA | WA |
| F | None | None | None | None | VWA | WA/None | WA/None | VWA | VWA | VWA | VWA |
| G | None | None | None | None | None | VWA | VWA | VWA | VWA | VWA | VWA |
| H | None | None | None | VW/None | VW/None | VWA | VWA | VWA | VWA | VWA | VWA |
| I | None | None | None | None | None | VWA | VWA | VWA | VWA | VWA | VWA |
| J | None | None | VWA | VWA | VWA | VWA | VWA | VWA | VWA | VWA | VWA |
| K | None | None | None | None | None | VWA | VWA | VWA | VWA | VWA | VWA |

Table 3 Key: A = Ammonia odor detected; WA = Weak Ammonia odor; VWA = Very Weak Ammonia odor; SA = Strong Ammonia odor; None = No odor. Ammonia (NH₃) is a colorless gas that is a compound of nitrogen and hydrogen. It has a strong odor that smells like urine or sweat.

The formaldehyde present in the UF may contribute to the generation of water. The stability test results summarized above show that UF containing boric acid (with or without propylene glycol) consistently maintains a lower pH and a lower ammonia odor than the control without boric acid. Addition of boric acid also improves the storage stability of the product, as tested at elevated temperatures over time. The feasibility of a buffered solution of UF, boric acid, and propylene glycol is supported. No separation or sediment was detected in any of the samples. Therefore, an inorganic compound such as boric acid provides benefits to the DEF in terms of stability and buffering, and allows for the treatment of UF compounds.

### B. Deposit Testing

Additional testing was done to evaluate the effectiveness of the DEF having boric acid on reducing deposits of urea residue that tend to form in the exhaust system (as described above). The tests were conducted by Powertrain Engineering, a division of Southwest Research Institute (SwRI), located in San Antonio, Texas. SwRI evaluated various DEF formulations for deposit production at specified steady-state operating conditions using SwRI's Exhaust Composition Transient Operation Laboratory™ (ECTO-Lab™) system. Modified DEF samples were compared to both the commercial (control) DEF of Sample No. 1 and the reference DEF of Sample No. 2 to determine deposit reduction efficacy.

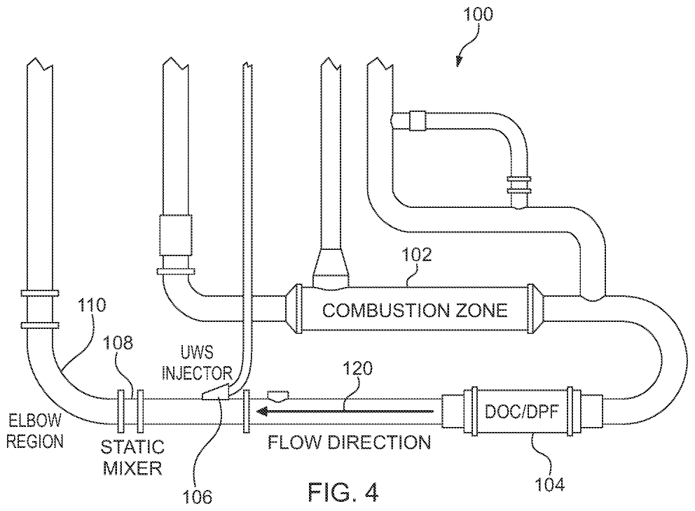

The ECTO-Lab system 100 used to conduct the tests is illustrated schematically in FIG. 4. The system 100 replicates the real time operation conditions in the field experienced by aftertreatment equipment for reducing harmful exhaust emissions from internal-combustion engines. (The combustion zone 102 of the system 100 simulates an engine.) In other words, aftertreatment equipment cleans exhaust gases to ensure the engines meet emission regulations. The exhaust gases in the system 100 flow in the direction 120 away from the combustion zone 102.

A DOC/DPF unit 104 is installed downstream of the combustion zone 102 and upstream of the DEF injector 106 to remove soot from the exhaust stream. The unit 104 includes a diesel particulate filter (DPF), which collects and oxidizes carbon to remove particulate matter (PM) by more than 90%, and a diesel oxidation catalyst (DOC) which aids in this process. The exhaust stream passes from the combustion zone 102 through the DOC and enters the DPF. After collecting the particles from the exhaust gases in the DOC/DPF unit 104, there is still nitric oxide (NO) and nitrogen dioxide (NO₂) left in the exhaust stream. In order to reduce the NOₓ levels a light mist of DEF is injected into the hot exhaust stream.

Thus, the exhaust gas enters the DEF injector 106 after exiting the DOC/DPF unit 104. In the system 100, a Denoxtronix 2.2 urea dosing device for SCR systems, available from Robert Bosch GmbH of Germany, was used for the DEF injector 106. The DEF injector 106 is mounted on a static mixer 108, which is located about 50 mm downstream of the DEF injection location. In the system 100, the static mixer 108 has a corrugated wire mesh configured to enhance mixing of DEF spray with the exhaust stream and to promote increased evaporation. The static mixer 108 is Part Number RE565070-0422-00200 available from Deere & Company, doing business as John Deere, of Moline, Illinois. After exiting the static mixer 108, the exhaust stream passes through an elbow region 110 in the pipe through which the exhaust stream travels.

A summary of the testing protocol follows. Regeneration was performed at the beginning of every test and both the static mixer 108 and the elbow region 110 were removed from the system 100 (i.e., disassembled) to measure their baseline weights. The testing temperature (either 180° C. or 215° C.) was measured at the center of the exhaust gas flow immediately upstream of the DEF injector 106. The test condition was stabilized for at least five minutes before initiating DEF injection. The DEF injection pressure was set to 9 or 10 bar. At the conclusion of each test, the static mixer 108 and the elbow region 110 were again removed from the system 100, and photographs were taken on the upstream and downstream sides of the static mixer 108 and the elbow region 110 as well as at the tip of the DEF injector 106. Deposits were physically scraped from the internal surfaces of the static mixer 108 and the elbow region 110, and the deposit masses were quantified at each location. Quantification was gravimetric by weighing all collected deposits on an analytical balance. The static mixer 108 and the elbow region 110 were rinsed with deionized water to remove any residual deposits/DEF additives before proceeding with the next test. As a final step, the system 100 was reassembled and regenerated by heating to 550° C. at an exhaust flow rate of 1,200 kg/hr.

The two Tables below show the results of test data for seven different samples of DEF reflecting residue deposits using the system 100. Table 4 identifies the samples and Table 5 provides the residue test results (in grams) for each sample measured at two different exhaust temperatures: 180° C. and 215° C.

TABLE 4
(Sample Identification)

| Sample | |
|---|---|
| No. | Sample Description |
| 1 | Control = Commercial urea liquor (UL) from Colonial Chemical |
| | Company of about 32.5% urea + 67.5% water (which meets the |
| | ISO 22241 specification) |
| 2 | Reference = Conventional DEF Provided by SwRI |
| 3 | Not Applicable |
| 4 | Urea-formaldehyde + 0.5% boric acid |
| 5 | Urea-formaldehyde + 1% boric acid |
| 6 | Urea-formaldehyde + 1.0% boric acid + 1% propylene glycol |
| 7 | Control UL + 1.0% boric acid |
| 8 | Urea-formaldehyde + 1.0% boric acid + |
| | 0.009% surfactant (9.5M nonylphenol ethoxylate) |

TABLE 5
(Residue Measured in Grams)

| | | SAMPLE No.: | | | | | | |
|---|---|---|---|---|---|---|---|---|
| Temperature | Location | 1 | 2 | 4 | 5 | 6 | 7 | 8 |
| 180° C. | Total | 39.1 | 40 ± 1 | 35.9 | 30.8 | 28.5 | 43.9 | 33.3 |
| 180° C. | % Reduction | N/A | N/A | 8.2 | 21.2 | 27.1 | 0 | 14.8 |
| 180° C. | Mixer | 10.3 | ±1.1 | 9.7 | 3.3 | 2.6 | 5.1 | 7.2 |
| 180° C. | Elbow | 28.8 | ±1.3 | 26.4 | 27.5 | 25.9 | 38.8 | 26.1 |
| 215° C. | Total | 21.9 | 22 ± 2.5 | 17.6 | 5.6 | 5.6 | 7.3 | 5.7 |
| 215° C. | % Reduction | N/A | N/A | 19.6 | 74.4 | 74.4 | 66.7 | 74.0 |
| 215° C. | Mixer | 5.8 | ±0.25 | 3.5 | 2.5 | 2.3 | 5.9 | 4.1 |
| 215° C. | Elbow | 16.1 | ±1.3 | 14.1 | 3.1 | 3.3 | 1.4 | 1.6 |

The “% Reduction” in Table 5 is the reduction in the amount of total residue achieved by Samples 4-8 relative to the control (Sample 1). Thus, for example, the % Reduction for Sample 4 at 180° C. is calculated as (39.1−35.9)/39.1=8.2%.

The addition of boric acid or ammonium borate to DEF releases water at elevated temperatures (>140° C.) as an inorganic additive to reduce residue. This was proven to be true for boric acid based on SwRI testing; see Samples 4, 5, 6, and 8. Sample 7 showed no negative effect from the addition of the inorganic additive to DEF. In addition to helping to reduce residue in use, it has been discovered that boric acid interferes (by reacting) with the formaldehyde treatment on the granular urea, so that it meets the ISO 22241 criteria for aldehyde content, Annex F, of less than 5 ppm.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure. It is expressly intended, for example, that all ranges broadly recited in this document include within their scope all narrower ranges which fall within the broader ranges.

What is claimed:

1. A diesel exhaust fluid (DEF) for reducing nitrogen oxides in diesel exhaust streams while also reducing the deposition of urea and/or urea decomposition compounds in diesel exhaust systems of engines that use DEF and require selective catalytic reduction, the DEF comprising:
about 15 wt. % to about 40 wt % urea;
substantially purified water; and
an inorganic compound additive that generates water in the diesel exhaust streams at temperatures greater than 100° C., interferes with competing reactions that would otherwise prevent decomposition of urea or produce undesired decomposition deposit compounds including biuret, cyanuric acid, ammelide, ammeline, and melamine, or both generates water and interferes with the competing reactions.

2. The DEF according to claim 1, wherein the inorganic compound additive is boric acid or ammonium borate.

3. The DEF according to claim 2, wherein the inorganic compound additive is boric acid having a maximum amount of 12 ppm sulfate or sulphate ion.

4. The DEF according to claim 2, wherein the inorganic compound additive is boric acid present in the DEF in an amount within the range of about 0.1 to 3% by weight.

5. The DEF according to claim 4, wherein the amount of boric acid is within the range of about 0.1 to 2% by weight.

6. The DEF according to claim 5, wherein the amount of boric acid is within the range of about 0.1 to 1% by weight.

7. The DEF according to claim 6, wherein the urea is present in the DEF in an amount of about 32.5% by weight.

8. The DEF according to claim 1, wherein the urea includes formaldehyde and the DEF has less than 5 ppm of formaldehyde.

9. A method for reducing nitrogen oxides in diesel exhaust streams while also reducing the deposition of urea and/or urea decomposition compounds in diesel exhaust systems of engines that use diesel exhaust fluid (DEF) and require selective catalytic reduction (SCR), the method comprising:
providing a DEF having (a) about 15 wt. % to about 40 wt % urea, (b) substantially purified water, and (c) an inorganic compound additive that generates water in the diesel exhaust streams at temperatures greater than 100° C., interferes with competing reactions that would otherwise prevent decomposition of urea or produce undesired decomposition deposit compounds including biuret, cyanuric acid, ammelide, ammeline, and melamine, or both generates water and interferes with the competing reactions; and
introducing the DEF into a diesel exhaust system such that the DEF reacts with nitrogen oxides on the surface of a SCR catalyst while also reducing the deposition of urea and/or urea decomposition compounds in the diesel exhaust system.

10. The method according to claim 9, wherein the step of providing the DEF includes providing a DEF having boric acid or ammonium borate as the inorganic compound additive.

11. The method according to claim 10, wherein the inorganic compound additive is boric acid having a maximum amount of 12 ppm sulfate or sulphate ion.

12. The method according to claim 10, wherein the inorganic compound additive is boric acid present in the DEF in an amount within the range of about 0.1 to 3% by weight.

13. The method according to claim 12, wherein the amount of boric acid is within the range of about 0.1 to 2% by weight.

14. The method according to claim 13, wherein the amount of boric acid is within the range of about 0.1 to 1% by weight.

15. The method according to claim 14, wherein the urea is present in the DEF in an amount of about 32.5% by weight.

16. The method according to claim 9, wherein the urea includes formaldehyde and the DEF has less than 5 ppm of formaldehyde.

17. The method according to claim 9 further comprising the step, before the step of introducing the DEF into a diesel exhaust system, of contacting the DEF with an ion exchange resin and adsorbing impurities from the DEF.

18. A system for reducing nitrogen oxides in diesel exhaust streams while also reducing the deposition of urea and/or urea decomposition compounds in diesel exhaust units of engines that use diesel exhaust fluid (DEF) and require selective catalytic reduction (SCR), the system comprising:
a DEF having (a) about 15 wt. % to about 40 wt % urea, (b) substantially purified water, and (c) an inorganic compound additive that generates water in the diesel exhaust streams at temperatures greater than 100° C., interferes with competing reactions that would otherwise prevent decomposition of urea or produce undesired decomposition deposit compounds including biuret, cyanuric acid, ammelide, ammeline, and melamine, or both generates water and interferes with the competing reactions;
a storage vessel containing the DEF;
a SCR catalyst positioned within the diesel exhaust unit and having a surface; and
a delivery tube connecting the storage vessel to the diesel exhaust unit and delivering the DEF from the storage vessel to the diesel exhaust unit onto or near the surface of the SCR catalyst.

19. The system according to claim 18, wherein the inorganic compound additive is boric acid or ammonium borate.

20. The system according to claim 19, wherein the inorganic compound additive is boric acid having a maximum amount of 12 ppm sulfate or sulphate ion.

21. The system according to claim 19, wherein the inorganic compound additive is boric acid present in the DEF in an amount within the range of about 0.1 to 3% by weight.

22. The system according to claim 21, wherein the amount of boric acid is within the range of about 0.1 to 2% by weight.

23. The system according to claim 22, wherein the amount of boric acid is within the range of about 0.1 to 1% by weight.

24. The system according to claim 23, wherein the urea is present in the DEF in an amount of about 32.5% by weight.

25. The system according to claim 18, wherein the urea includes formaldehyde and the DEF has less than 5 ppm of formaldehyde.
